(19) United States
(12) Patent Application Publication
(10) Pub. No.: US 2016/0283991 A1
(43) Pub. Date: Sep. 29, 2016

(54) METHOD AND SYSTEM FOR CREDITING PHYSICAL VENDORS WITH ONLINE PURCHASES

(71) Applicant: Nicole Denise SENYARD, West Vancouver (CA)

(72) Inventor: Nicole Denise SENYARD, West Vancouver (CA)

(21) Appl. No.: 15/079,742

(22) Filed: Mar. 24, 2016

Related U.S. Application Data
(60) Provisional application No. 62/139,249, filed on Mar. 27, 2015.

(51) Int. Cl. G06Q 30/06

(52) U.S. Cl. CPC G06Q 30/0601

(57) ABSTRACT

The present disclosure relates to a computer network and system for managing lottery ticket sales of both online merchants and physical vendors. The present disclosure is directed to improvements in electronic lottery devices, systems and networks. A system comprises: a physical vendor material comprising a unique code, an internet-connected user device, an online merchant platform, and a server. The server stores a plurality of unique codes, user account identifications, and physical vendor identifications. The server creates at least one record associating the user account identification transmitted with the unique code to the physical vendor identification previously associated with the unique code. The server generates a transaction to credit the physical vendor based on an online user activity.

### CROSS REFERENCE TO RELATED APPLICATIONS

This application claims the benefit of priority of U.S. Provisional Patent Application No. 62/139,249 filed Mar. 27, 2015, which is incorporated herein by reference.

### FIELD

The present disclosure relates to electronic lottery systems with enhanced customer and vendor services for promoting customer and vendor loyalty.

### BACKGROUND

In the traditional American lottery structure, the lottery is a legal form of gaming, usually run by state commissions. Like tax revenue, the state government may use revenue from running its lottery for various public purposes. In the United States, for example, the state commissions individually offer proprietary lottery products; most state commissions also cooperate in a consortium to offer multi-jurisdictional lotteries, such a Powerball™ and Mega Millions (TM), which effectively serve as national lotteries. The Powerball™ and Mega Millions™ lotteries reach a large audience of eligible players and can routinely generate jackpots in the hundreds of millions of dollars.

A lottery player typically buys a lottery ticket by visiting a physical retail location such as a store or kiosk licensed to sell lottery products. In many cases, the physical retail locations are operated by vendors, such as convenience stores. These vendors represent the point of sale aspect of the state lottery business by distributing tickets, receiving payment, answering common customer questions, and providing retail services and advertising for other lottery products; they may be referred to as “physical” or “brick and mortar” vendors. Physical vendors are an important partner in the state lottery business because the physical vendors provide many necessary and desirable customer services inherent to physical retail. The physical vendor typically earns revenue from the sale of lottery tickets by receiving a commission fee from the state lottery based on the lottery products sold. The physical vendor further benefits from offering lottery products because the sale of lottery products attracts customer traffic to the physical vendor location; more customer traffic corresponds to a greater likelihood of selling additional complementary products to the lottery ticket customer.

Recently, some state lotteries have added online lottery services so that players can purchase lottery products using their personal internet-connected devices at home, work, or elsewhere, without needing to visit a physical vendor location. To the state lottery business, online merchandising provides advantages such as user registration, behavior tracking, direct advertising, abuse identification, and access to a larger audience of potential customers. To the user or player, online merchandising provides advantages such as purchasing convenience, player history, subscriptions/auto-play, digital persistence of lottery tickets, automatic win notifications, and abuse identification.

The online merchandising of lottery tickets represents perceived competition to traditional physical vendors. Physical vendors risk losing out on the commission fee for each lottery ticket sold via an online merchandising platform, which may also impact the volume of complementary in-store purchases driven by the lottery ticket traffic. State lotteries are keen to innovate by moving lottery ticket merchandising online, and at the same time, aim to maintain strong relationships with their physical vendor partners.

State lotteries aim to maintain strong partnerships with their physical vendors because these entities represent the most common method for players to purchase lottery tickets. Lottery players may currently still prefer physical vendors for a number of reasons, including a slow adoption or outright distrust of technology, a preference for anonymous cash transactions, and behavioral complacency. Casual lottery players may also dislike online registration and may find physical vendors more convenient.

Moreover, many state lotteries are dependent on physical vendors to sell alternative products offered by the state lotteries. For example, a state lottery may offer both traditional lottery tickets (like Powerball, based on periodically-drawn numbers) and also scratch tickets (which is typically a card pre-configured to some redemption outcome); therefore, the state lottery may implement online merchandising for the traditional lottery tickets and depend on physical vendors to carry and sell the scratch tickets.

Accordingly, state lotteries seek a sustainable solution to solidify their partnerships with physical vendors while innovating their digital lottery product offering.

### BRIEF DESCRIPTION OF THE DRAWINGS

Embodiments of the present disclosure will now be described, by way of example only, with reference to the attached Figures.

FIG. 1 is a diagram of a conventional lottery network.

FIG. 2 is a diagram of a lottery system, according to an embodiment of the present disclosure.

FIG. 3 is a diagram of different examples of physical vendor materials, according to embodiments of the present disclosure.

FIG. 4 is a diagram of a database table for recording associations between a physical vendor and unique codes.

FIG. 5 is a diagram of a database table for recording associations between a user account identification and a unique code.

FIG. 6 is a diagram of a database table for recording online transactions of a user of the lottery system according to embodiments of the present disclosure.

FIG. 7 is a diagram of a database table for recording credits to a physical vendor.

FIG. 8 is a flowchart diagram showing a method of operating the lottery network according to an embodiment of the present disclosure.

FIG. 9 is a block diagram of an example electronic device that may be used in implementing one or more aspects or components according to the present disclosure.

### DETAILED DESCRIPTION

Generally, the present disclosure relates to a computer network and system for managing lottery ticket sales of both online merchants and physical vendors. The present disclosure is directed to improvements in electronic lottery devices, systems and networks. The management network of the present disclosure may incentivize the physical vendors to promote the online lottery service by crediting the physical vendors based on the online activity of users.

According to the present embodiments, the electronic lottery system is configured to associate a unique code to physical vendors, distribute the unique code to customers of the physical vendors, and record when the customers registers the unique code in an online platform. When this happens, the electronic system associates the online account of the customer with the physical vendor from which the customer acquired the unique code. Accordingly, the subsequent online activities and transactions of the customer are electronically tracked and used to credit the physical vendor associated with the customer. This allows for unique commission deals to be associated with the vendors for life-time player value tracking and reporting. The system can be configured to track various activities. Activities which can be tracked and reported include, but are not limited to i) player registrations; ii) player deposits; and iii) player games activity. Possible unique code distribution channels include, but are not limited to i) flyers with special online discount codes; ii) purchasable cards for discounts and player points; and iii) lottery tickets sold and/or redeemed.

With the presently described system, physical vendors can earn performance-based revenue for customers referred to the lottery corporation's online business. The physical vendor revenue may be based on a “player quality” rating defined by the online activity of the referred customers. Player quality is understood in the present context as one who plays the games hosted by the lottery system, in one example. Other measurable parameters can be used to further establish the importance or value of the player to the lottery system. Furthermore, physical vendors are able to login to a web-based system as a third-party account to view earnings specific to the referred customer's online purchases. The physical vendors may also see data related to customer volumes and values by customer IDs only. In an embodiment, no personal information is collected or stored. The central lottery authority may view their online user acquisition efforts via different physical vendor affiliates and alternative digital channels as well.

According to an embodiment of the present disclosure, a physical vendor crediting system comprises: a physical vendor material comprising a unique code, each code being associated with a physical vendor identification; an internet-connected user device configured to receive the unique code from an input and transmit, via an online user activity, the unique code with a user account identification to an online merchant platform; and a server connected to the online merchant platform for storing a plurality of unique codes, user account identifications, and physical vendor identifications, the server configured to: create at least one record associating the user account identification transmitted with the unique code to the physical vendor identification previously associated with the unique code, and generate a transaction to credit the physical vendor based on the online user activity.

In a further embodiment, the system comprises a relational database for storing the at least one record associating the user account identification to the physical vendor identification.

According to another embodiment of the present disclosure, a method for crediting a physical vendor based on an online user activity comprises: associating, at a server, a unique code of a physical vendor material with a physical vendor identification; inputting the unique code at an internet-connected user device; transmitting, via the online user activity, the unique code with a user account identification to an online merchant platform, the online merchant platform being connected to the server; creating, at the server, at least one record associating the user account identification transmitted with the unique code to the physical vendor identification previously associated with the unique code; and generating a transaction to credit the physical vendor based on the online user activity.

In a further embodiment, the method comprises storing the at least one record associating the user account identification to the physical vendor identification in a relational database.

In a further embodiment, the unique code is a serial number, a barcode, or a two-dimensional barcode printed on the physical vendor material.

In a further embodiment, the unique code is encoded in a radio-frequency identification (RFID) tag stored on the physical vendor material.

In a further embodiment, the physical vendor material is a pre-paid lottery card, a lottery ticket receipt, a flyer, a coupon, or a scratch ticket.

In a further embodiment, the server is configured to calculate an amount of the credit based on a number of records associating the same physical vendor identification and user account identification.

In a further embodiment, the server is configured to calculate an amount of the credit based on a volume of the online user activity.

In a further embodiment, the server is configured to calculate an amount of the credit based on a type of the online user activity.

In a further embodiment, the server is configured to calculate an amount of the credit based on a date of the online user activity.

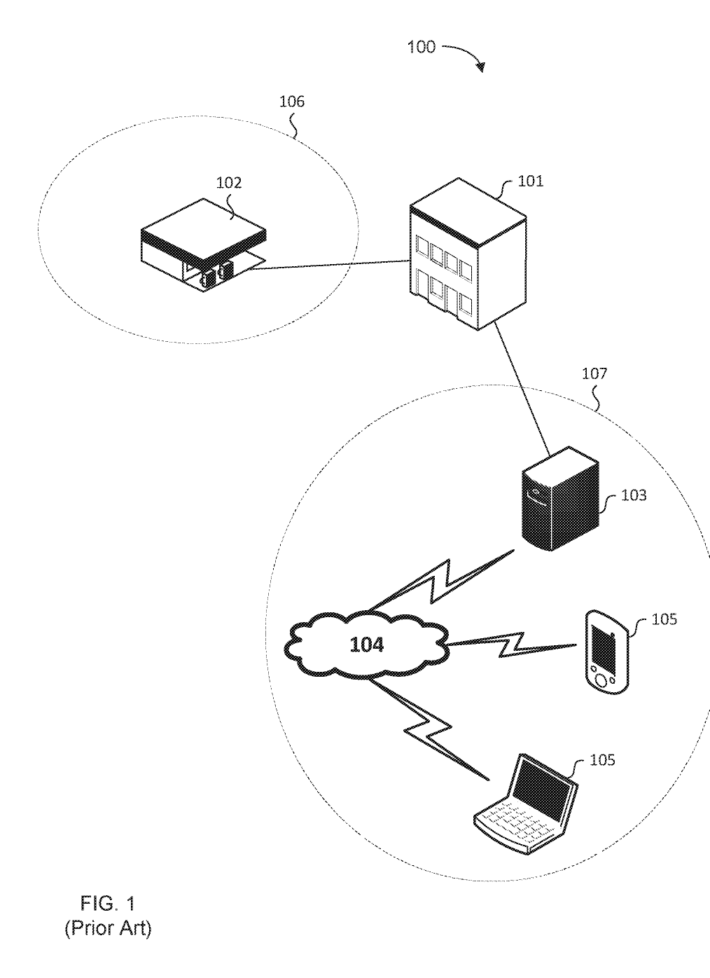

FIG. 1 is a diagram of a conventional lottery network 100. In one aspect, the lottery network 100 comprises a state lottery server 101 in communication with multiple physical vendor terminals 102, of which only one is shown. In a second aspect of the network 100, the state lottery server 101 is in communication with an online merchant platform 103. Even though the physical vendor terminals 102 and the online merchant platform 103 are both connected to the state lottery's server 101, the physical vendor's operations 106 are separate and independent of the online merchant's operations 107.

The physical vendor terminals 102 have point of sale hardware and software to process a customer's lottery ticket purchase. When the customer purchases a lottery ticket at the physical vendor terminal 102, the physical vendor terminal 102 receives payment from the customer by any applicable means (cash, debit, credit, etc.) and communicates with the state lottery server 101 to register a lottery ticket according to the draw numbers chosen by the user. The state lottery server 101 communicates with the physical vendor terminal 102 to print out a physical ticket at the physical vendor terminal 102 for the customer to retain. The customer must use the printed physical ticket to redeem any winnings.

The online merchant platform 103 is in communication, via the internet 104, with multiple internet-connected user devices 105. Examples of internet-connected user devices 105 include personal computers, laptops, tablets, and smartphones. The online merchant platform 103 may manage user registration, including receiving user identification and payment information. When the online merchant platform 103 receives a lottery ticket purchase instruction from the user device 105, the online merchant platform 103 charges the user-registered account according to the user-provided payment information. The online merchant platform 103 also communicates with the state lottery server 101 to register a lottery ticket according to the draw numbers chosen by the user. Electronic confirmation of the lottery ticket number may be stored at the online merchant platform 103 and provided to the user. In various implementations, the state lottery server 101 and the online merchant platform 103 may be co-located together or the functions of the online merchant platform 103 may be integrated into the state lottery server 101 as a single subsystem.

In the conventional lottery network 100, the physical vendor's operations 106 are completely separate and independent of the online merchant's operations 107, even though the physical vendor terminals 102 and the online merchant platform 103 are both connected to the state lottery's server 101. While the conventional lottery network 100 may support both the physical vendor's operations 106 and the online merchant's operations 107, the conventional lottery network 100 cannot avoid alienating physical vendors for the migration of lottery ticket sales from the physical vendor to online merchants. A player may first purchase lottery tickets from the physical vendor and then purchase lottery tickets from the online merchant, or vice versa, and neither the physical vendor nor the online merchant would be aware of the player's activities with the other party. Furthermore, in the conventional lottery network 100, the state lottery would also not be aware of players that are purchasing lottery tickets from both physical vendors and online merchants or that are migrating their purchasing habits from one to another.

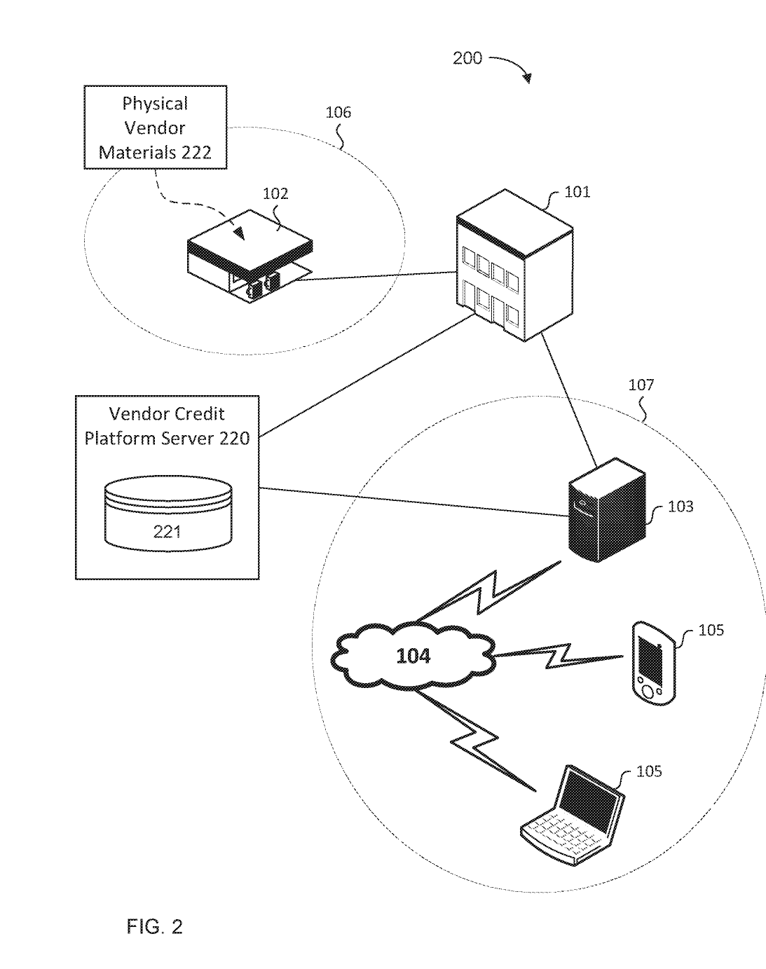

FIG. 2 is a diagram of the lottery system of a present embodiment, which is now briefly described. A lottery network 200 comprises a state lottery server 101 in electronic communication with multiple physical vendor terminals 102. The physical vendor terminals 102 have point of sale hardware and software to process a customer's lottery ticket purchase. The state lottery server 101 is also in electronic communication with an online merchant platform 103. In various implementations, the state lottery server 101 and the online merchant platform 103 may be co-located together or the functions of the online merchant platform 103 may be integrated into the state lottery server 101 as a single subsystem. The online merchant platform 103 is in communication, via the internet 104, with multiple internet-connected user devices 105.

The network 200 further comprises a vendor credit platform server 220, which may comprise a database 221 in various embodiments, and physical vendor materials 222. Records of the physical vendor materials 222 may be stored in the database 221 in order to associate the physical vendor materials 222 to the server 220. The state lottery server 101 and the vendor credit platform server 220 may be in communication with each other or co-located together; alternatively, the functions of the vendor credit platform server 220 may be integrated into the state lottery server 101 as a single subsystem. The vendor credit platform server 220 and the physical vendor materials 222 link the physical vendor's operations 106 to the online merchant's operations 107. As further explained below, the records of the physical vendor materials may also include relational links to user accounts and vendor accounts.

By virtue of the relational links between user accounts and vendor accounts via the records of the physical vendor materials, the server 220 and materials 222 allow the state lottery to credit the physical vendor for certain online activities of lottery players; the credit may be a monetary value or a proprietary point value with a monetary equivalent. The act of crediting the physical vendor may be in the form of a monetary transaction or may be in the form of discounts to be applied to future purchases from the state lottery corporation. Thus, the state lottery may strengthen relationships with physical vendors when implementing an online merchant platform and incentivize physical vendors to promote the online merchant platform.

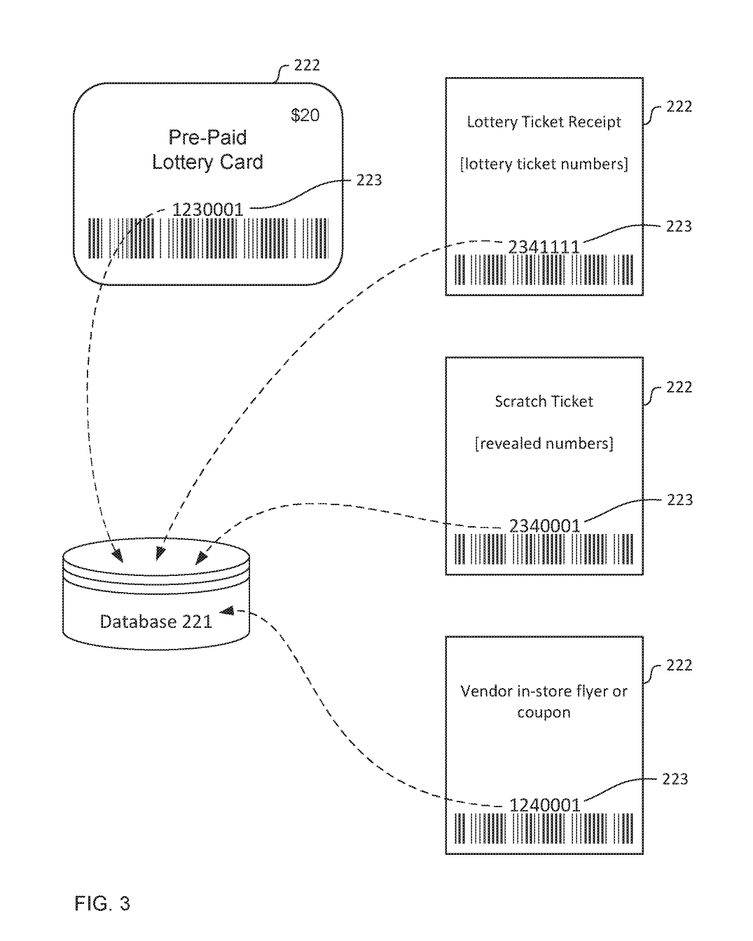

FIG. 3 is a diagram of various different examples of physical vendor materials 222. Physical vendor materials 222 are items provided by the physical vendor 102 to a customer so that the physical vendor 102 is associated with the customer's subsequent online lottery activities. By associating the physical vendor 102 to a customer's online activity, the physical vendor 102 can be credited for the customer's online transactions.

The physical vendor materials 222 may take the form of a pre-paid lottery card, a lottery ticket receipt, a scratch ticket, or an in-store distributed flyer or an in-store distributed coupon for example. Each of these physical vendor materials 222 includes a unique identifier number or code 223. The unique code 223 may also be known as a serial number or serial code. In further embodiments, the unique code 223 may be encoded in a printed, scannable barcode, a two-dimensional barcode (also known as a QR code), a near field radio frequency code (also known as RFID), or any other suitable code.

The database 221 contains records of each unique code 223 associated with a physical vendor. The database 221 may also record the type of physical vendor material 222 on which the unique code 223 is printed. For example, the database 221 may contain records for a given physical vendor. The physical vendor sells conventional lottery tickets, which is a form of physical vendor material 222. When a lottery customer buys a lottery ticket at the physical vendor's point of sale terminal, the terminal prints a lottery ticket receipt for the customer. In addition to the lottery number printed on a ticket receipt for redeeming winnings, the lottery ticket receipt also includes the unique code 223. The customer may be incentivized to enter the unique code 223 on the online merchant platform 103 through discount or prize offers. The unique code 223 is assigned by the server 220 to the physical vendor; therefore, the database 221 records the association between the physical vendor and the unique code 223 and indicates that the unique code 223 came from a printed lottery ticket receipt.

The physical vendor may also offer pre-paid lottery cards for sale as the form of physical vendor material 222. The pre-paid lottery card also includes the unique code 223, which has previously been assigned to the physical vendor. The customer may use the unique code 223 to redeem the value on the pre-paid lottery card for transactions on the online merchant platform 103. Therefore, the database 221 records the association between the physical vendor and the unique code 223 and indicates that the unique code 223 came from a pre-paid lottery card.

The physical vendor may also offer in-store flyers or coupons. The flyer or coupon includes the unique code 223, which may also act as a discount code. The customer may use the unique code 223 to discount transactions on the online merchant platform 103. Therefore, the database 221 records the association between the physical vendor and the unique code 223 and indicates that the unique code 223 came from a flyer or coupon.

The physical vendor may also offer scratch tickets from the state lottery for sale as the form of physical vendor material 222. The scratch ticket includes the unique code 223. The customer may be incentivized to enter the unique code 223 on the online merchant platform 103 through discount or prize offers. Therefore, the database 221 records the association between the physical vendor and the unique code 223 and indicates that the unique code 223 came from a scratch ticket.

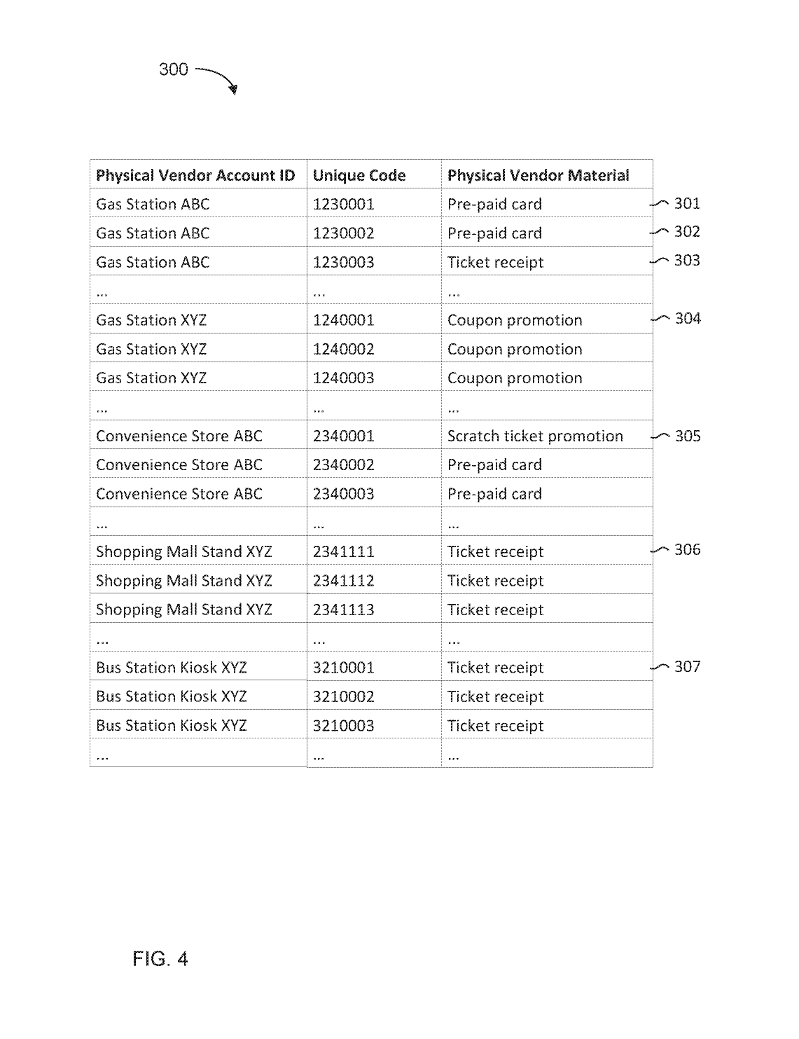

FIG. 4 is a diagram of an example database table 300 of the relational database 221. The table 300 records associations between a physical vendor 102 and unique codes 223. The physical vendor 102 is identified in the table 300 by a physical vendor account identification. In a further embodiment, the table 300 may also record the type of physical vendor material 222 on which the unique code is carried. Table 300 comprises records 301 to 307, which are shown for illustrative purposes only. Records 301 to 303 are each associated with a physical vendor “Gas Station ABC”. Record 301 registers a pre-paid lottery card having the unique code “1230001” with the Gas Station ABC. Similarly, record 302 registers a pre-paid card having the unique code “1230002” with the Gas Station ABC; whereas record 303 registers a lottery ticket receipt having the unique code “1230003” with the Gas Station ABC.

Record 304 registers a coupon having the unique code “124001” with a Gas Station XYZ. Record 305 registers a scratch ticket card having the unique code “2340001” with the Convenience Store ABC. Record 306 registers a lottery ticket receipt having the unique code “2341111” with a Shopping Mall Stand XYZ. Record 307 registers a lottery ticket receipt having the unique code “3210001” with a Bus Station Kiosk XYZ. Table 300 shows additional records, which illustrate how various combinations of unique codes 223 and physical vendor material 222 types may be associated with physical vendors.

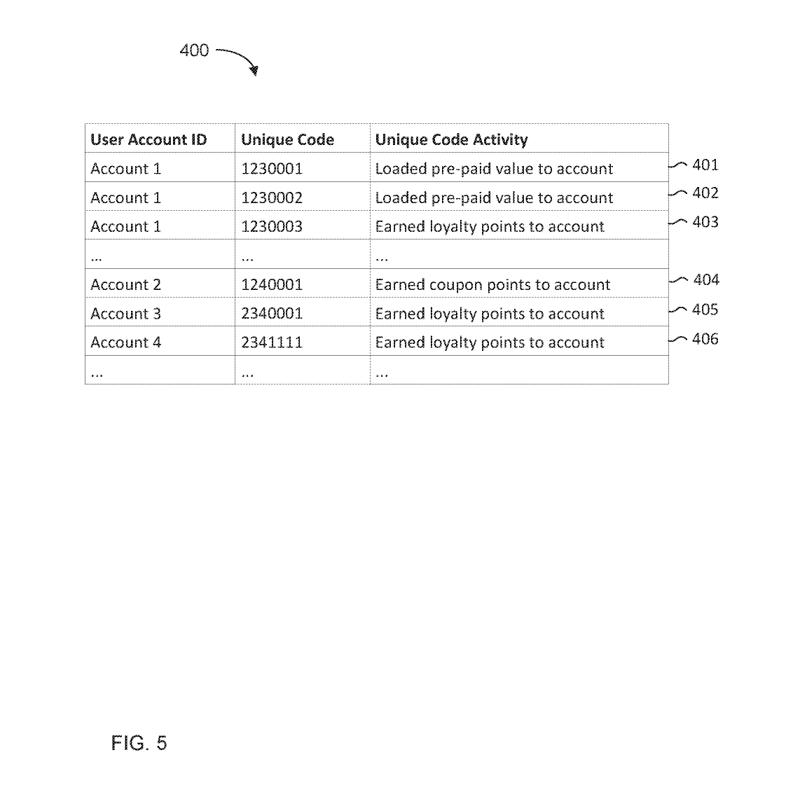

FIG. 5 is a diagram of an example database table 400 of the relational database 221. The table 400 records associations between a user account identification and a unique code 223. According to an embodiment of the system 200, the user receives the physical vendor materials 222 from the physical vendor 102. Sometime before or after receiving the physical vendor materials, the user registers a user account on the vendor credit platform server 220 via a user interface to the server or via the online merchant platform 103. The user can use the device 105 to perform the registration and other subsequent actions with the online merchant platform 103. Through the user interface of the server 220 or the online merchant platform 103, the user can input the unique code 223 printed on the materials 222. The user may be motivated to register the user account and to input the unique code 223 because the state lottery can offer the user benefits such as prizes, redemption points, or discounts.

In a further embodiment, the table 400 also records how the user redeemed the unique code 223. The table 400 comprises records 401 to 406, which are shown for illustrative purposes only. The user account information in each record 401 to 406 is captured by the online merchant platform 103 and provided to the database 221 where the records are created.

For example, record 401 shows that the user loaded the value of a pre-paid lottery card to the user's online account. The unique code “1230001” of the record 401 also corresponds to the unique code of the record 301 in table 300. Therefore, the vendor credit platform server 220 can determine that the pre-paid lottery card used in record 401 was purchased from the Gas Station ABC. Associating a user account, in the record 401, to a physical vendor, in the record 301, allows the server 220 to credit the physical vendor for one or more subsequent online activities of the user.

Similarly, the server 220 can compare the records in table 400 to the records in table 300 to determine that: the pre-paid card in record 402 was also purchased from Gas Station ABC in record 302; and the lottery ticket receipt (used for earning loyalty points) in record 403 was also purchased from the Gas Station ABC in record 303. In an embodiment of the present disclosure, the server 220 is configured to have the flexibility to increase the amount of credits to the physical vendor when multiple unique codes are associated with the physical vendor. In the above example, the Gas Station ABC has a repeat customer who has bought two pre-paid lottery cards and one lottery ticket from the Gas Station ABC. Thus, the Gas Station ABC may earn more credit based on the online activity of the repeat customer because the repeat customer represents a greater loss to the physical vendor or a greater gain to the online merchant platform.

In a similar fashion, the server 220 can associate the Account 2 user account (in record 404) to the Gas Station XYZ (in record 304) via the unique code “1240001” common to both records 304 and 404. Likewise, the server 220 can associate the Account 3 user account (in record 405) to the Convenience Store ABC (in record 305) via the unique code “2340001” common to both records 305 and 405; and the server 220 can associate the

Account 4 user account (in record 406) to the Shopping Mall Stand XYZ (in record 306) via the unique code “2341111” common to both records 306 and 406.

After a user account is associated with a physical vendor, the server 220 may then track the user's online activities via the user account on the server 220 and credit the physical vendor for state lottery revenue generated from the user's online activities on the online merchant platform 103.

As can be seen by comparing table 400 to table 300, user “Account 1” has registered three unique codes and each unique code is associated with Gas Station ABC. Thus, Account 1 is associated with Gas Station ABC. In an embodiment, Account 1 is associated with a physical vendor 102 based on the earliest registered unique code 223. Therefore, in the example of table 400, Account 1 is associated with Gas Station ABC based on the unique code “1230001”; unique codes “1230002” and “1230003” are not used to associate Account 1 to Gas Station ABC. Furthermore, in this example, should the user of Account 1 acquire the unique code “1240003” (which is associated to Gas Station XYZ in table 300) and then register the code “1240003” on the server 220, the Account 1 will not become associated with Gas Station XYZ because the Account 1 is already associated with Gas Station ABC.

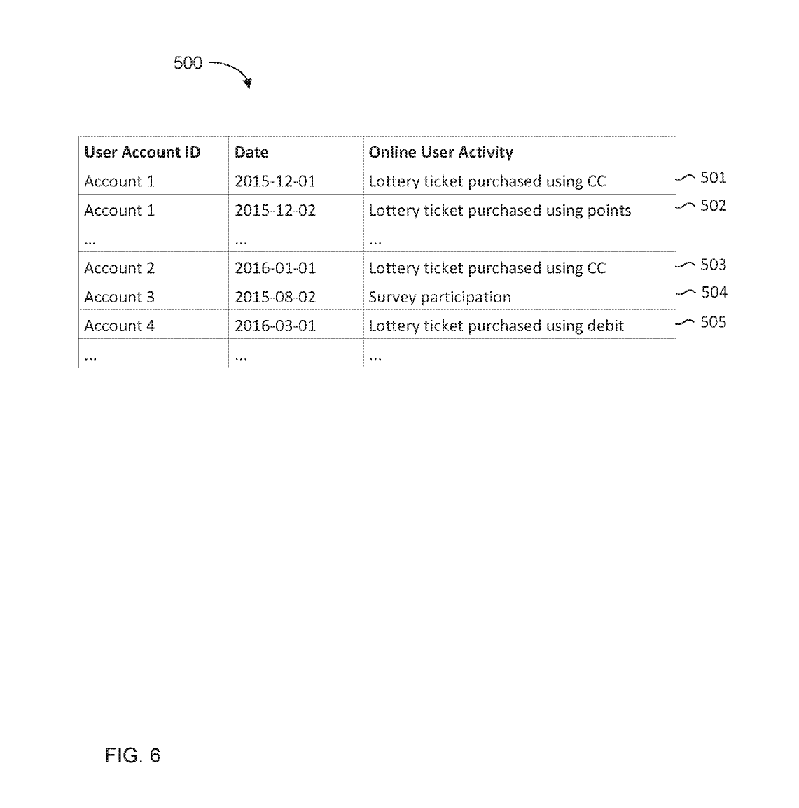

FIG. 6 is a diagram of an example database table 500 of the relational database 221. The table 500 records online transactions of a user of the lottery system according to embodiments of the present disclosure. The table 500 comprises records 501 to 505, which illustrate examples of user transactions executed by the online merchant platform 103. The user account information in each record 501 to 505 is captured by the online merchant platform 103 and provided to the database 221 where the records are created.

The server 220 may combine the information in the records of table 500 with the user account to physical vendor associations previously determined in order to credit a physical vendor for a user's online transactions. For example, the Account 1 user had previously loaded pre-paid value from a pre-paid card into his or her online user account, as shown in record 401. The server 220 had previously associated the Account 1 user to the Gas Station ABC based on the common unique code “1230001” in both records 301 and 401. The server 220 then receives further user account information, in the form of record 501, from the online merchant platform 103. The record 501 indicates that the Account 1 user has used a credit card to purchase a lottery ticket on the online merchant platform 103. Based on the record 501, the server 220 may calculate a credit for the Gas Station ABC. The credit may be a monetary value or a proprietary point value with a monetary equivalent. The calculation of the value of the credit may take the form of a flat fee based on the type of transaction, a percentage of the value of the transaction, or some other type of commission fee provided to the physical vendor by the state lottery corporation. In further embodiments, the credit value is calculated based on the volume of registered user accounts associated to the physical vendor, the volume of transactions associated to the physical vendor, or the volume of another precipitating event, such as redemption of promotional coupons. This credit, in the form of money or points, may incentivize the physical vendor to promote the state lottery's online merchant platform.

In another example, record 502 indicates that the Account 1 user has purchased a lottery ticket using accumulated points. The points may be loyalty points accumulated from buying a certain number of lottery tickets, or may be promotional points accumulated from redeeming coupons and flyers, or may be a combination of both. In an embodiment, the server 220 calculates a different credit value to Gas Station ABC for record 502 than for record 501. The server 220 may determine that a monetary transaction (e.g., cash, debit card, credit card) has more inherent value than a points transaction; therefore, the server 220 may provide more credit to the Gas Station ABC for record 501 than for record 502.

In yet further examples, the server 220 may calculate different credit values for records 504 and 505. For example, the server 220 may determine that survey participation has very low inherent value and a debit transaction has very high inherent value; therefore, the server 220 may provide the least credit, or no credit, to the Convenience Store ABC for the Account 3 user's survey participation, and provide the most credit to the Shopping Mall Stand XYZ for the Account 4 user's debit transaction.

In another embodiment, the table 500 comprises transaction date information.

The server 220 may also calculate a credit amount based on the transaction date information in a given record. For example, record 503 show a credit card transaction on New Year's day. The state lottery may be running a holiday promotion and may incentivize its physical vendor affiliates to emphatically promote the online merchant platform during that time period. Therefore, the server 220 may be configured to increase the credit value for the Account 2 user's credit card transaction (in record 503) as compared to the Account 1 user's credit card transaction (in record 501). Accordingly, the Gas Station XYZ may earn more credits than the Gas Station ABC for the same type of transaction because the transactions happened at different times.

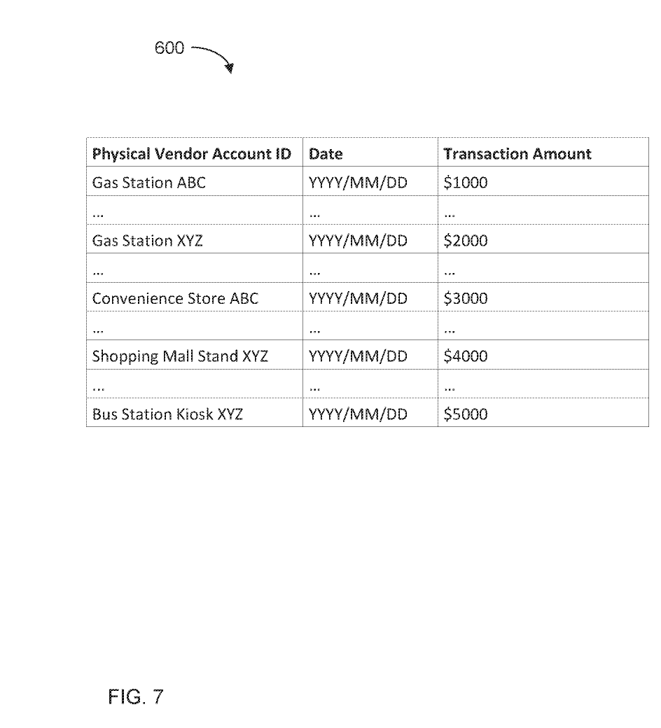

FIG. 7 is a diagram of an example database table 600 of the relational database 221. The table 600 is a ledger for recording transactions for crediting the physical vendors 102. The transactions in the table 600 are a result of the associations and calculations generated based on the relationships between tables 300, 400, and 500, above. The table 600 may identify the physical vendor account and include the date of each transaction and the amount of each transaction.

In an embodiment, the server 220 receives a batch of transactions from the state lottery server 101 or the online merchant platform 103. The server 220 then aggregates the batch of transactions into a single large transaction for periodically crediting the physical vendor 102. In other embodiments, the server 220 may operate at a different level of granularity; for example, the server 220 may record multiple smaller transactions rather than aggregating the batch of transactions.

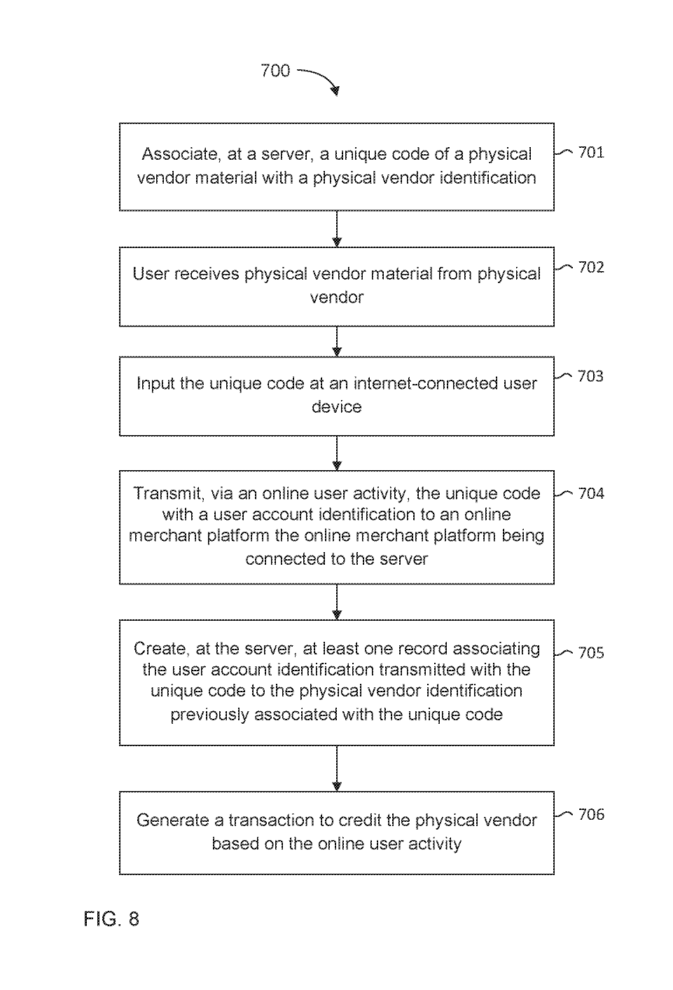

FIG. 8 is a flowchart diagram showing an example method 700 of operating the lottery network 200. Having described the various components of the lottery network 200, an example of the operation of the lottery network 200 will now be described with reference to both FIGS. 2 and 8. The vendor credit platform server 220 can be configured to store user data and physical vendor data, in the form of accounts and records. Links or associations are formed between user accounts and physical vendor accounts when a user obtains a unique code 223 from a physical vendor and registers the code online in the user account.

At 701, the server 220 and/or the database 221 associates or registers a unique code 223 with the physical vendor identification by storing a record in table 300 for example. The unique code 223 is associated with a physical vendor material 222, which is distributed by the physical vendor to a customer.

The customer subsequently becomes a user of the online merchant platform 103 in the following manner. At 702, the customer visits the physical vendor affiliated with the state lottery corporation. The customer may purchase a pre-paid lottery card encoded with a unique code in the form of a promotional code or a unique identifier number. Alternatively, physical vendor material may be a traditional lottery ticket or a coupon according to another example.

As described in 701, the unique code has already been associated with the physical retailer by the server. At 703, the customer may then visit the website or mobile app of the state lottery corporation from any computing or mobile device 105. Visiting the website accesses the online merchant platform of the state lottery; the customer may now create a user account with the online merchant platform. Using the unique code printed on the card, the customer can purchase online lottery tickets using the pre-paid value of the card or deposit the value of the pre-paid card into the user account.

At 704, the online merchant platform 103 transmits the user account identification along with the unique code to the server 220. The server 220 may store this data in a record in table 400 for example.

When the user of the online merchant platform 103 performs an online activity, such as purchasing a lottery ticket, the user's activity data is transmitted to the state lottery website by the web services or mobile apps of the online merchant platform. In parallel to transmitting the online user activity data to the state lottery, the online merchant platform 103 may also transmit the data to the server 220. Transmissions from the online merchant platform 103 to the server 220 may use proprietary web services or mobile software development kits (SDKs). The vendor credit platform server 220 is now able to track the user's subsequent lottery purchases and related activities from this point onwards. In an alternative embodiment, the state lottery also has the option to provide a batch of transactions accumulated daily or other periodic basis and deliver the batch to the server 220 ready to be uploaded. This alternative method can be done by way of btags or batch file tracking. This method may be used if there is no real-time or simultaneous transmission of the transactions to the server 220.

At 705, the server 220 creates at least one record associating the user account identification transmitted with the unique code to the physical vendor identification previously associated with the unique code.

At 706, the server 220 generates a transaction to credit the physical vendor 102 based on the online user activity. The server 220 may send the credit transaction data to the state lottery server 101. For example, the transaction data may be of the type stored in ledger table 600.

In a further embodiment of the present disclosure, the physical vendor may have access to the server 220. Each physical vendor may have an individual login to the server. The server 220 may track statistics for each physical vendor so that the physical vendors are able to run reports showing, for example, all the users (e.g., by user account number) that registered using the vendor-associated codes, be it promotional code, bonus code, etc. The state lottery may also login to the server 220 in order to create marketing campaigns and monitor the success of the campaigns by running revenue reports, which may be grouped by campaigns, ads and physical vendors. The server 220 may be configured to compile the activity of each user, including the type of games played, amount spent and earned, and the number of times each game is played, for example.

The server 220 may be configured to cater to the individual physical vendor 102 and/or to the state lottery server 101. The server 220 may be configured to track the purchases to the correct physical vendor and therefore automate the calculation of the appropriate commission for each physical vendor. Furthermore, the server 220 can be configured to execute various marketing campaigns and track revenue generated by the individual physical vendor referrers down to the level of the user.

The advantages of using the presently described lottery system embodiment is that lottery players can be easily converted from offline (e.g. conventional lottery activities at a physical retailer) to online (e.g. lottery activities at the online merchant platform) by implementing unique codes printed on physical vendor materials, distributing the materials to customers of the physical vendors, and allowing the customers to redeem the unique codes online. Thus, the physical vendors may earn credit from the online lottery purchases and activities of the customer.

The system helps to improve partnership between the state lottery corporation and the affiliated physical vendors. The improved partnership may incentivize the physical vendors to use their in-store and digital resources to promote the online lottery service of the state lottery corporation. For example, a physical vendor may be more willing to advertise the online lottery service using in-store billboards and posters that display a unique code 223. In a further example, a convenience store or gas station franchise, such as 7-Eleven™ for example, may have digital properties such as a mobile app and a website. The physical vendor may also be willing to advertise a unique code 223 and/or directly link to the online lottery service through the physical vendor's mobile app and website.

The system further allows third-party login for the individual physical vendors based on the vendor account ID. The system provides the ability to accurately track acquisitions through the unique codes, and the ability to report down to a user and ad level. With this system, state lotteries can also track acquisition or migration of customer from physical vendors to its online merchant platform.

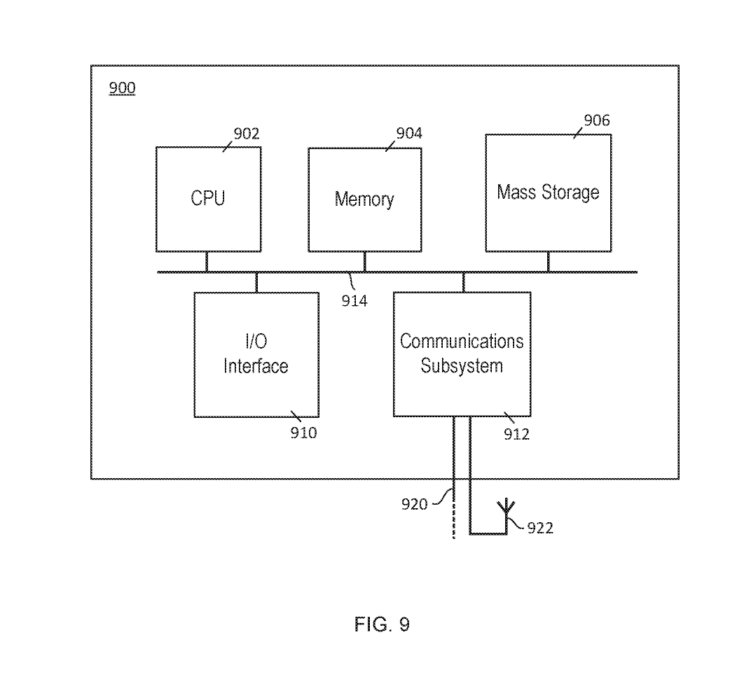

FIG. 9 is a block diagram of an example electronic device 900 that may be used in implementing one or more aspects or components of an embodiment according to the present disclosure, including but not limited to one or more of state lottery server 101, physical vendor terminals 102, online merchant platform 103, user devices 105, and vendor credit platform server 220.

The electronic device 900 may include one or more of a central processing unit (CPU) 902, memory 904, a mass storage device 906, an input/output (I/O) interface 910, and a communications subsystem 912. One or more of the components or subsystems of electronic device 900 may be interconnected by way of one or more buses 914 or in any other suitable manner.

The bus 914 may be one or more of any type of several bus architectures including a memory bus, storage bus, memory controller bus, peripheral bus, or the like. The CPU 902 may comprise any type of electronic data processor. The memory 904 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 906 may comprise any type or types of storage devices configured to store data, programs, databases (e.g. database 221), and other information and to make the data, programs, and other information accessible via the bus 914. The mass storage device 906 may comprise one or more of a solid state drive, hard disk drive, a magnetic disk drive, an optical disk drive, or the like. In some embodiments, data, programs, or other information may be stored remotely, for example in the “cloud”. Electronic device 900 may send or receive information to the remote storage in any suitable way, including via communications subsystem 912 over a network or other data communication medium.

The I/O interface 910 may provide interfaces to couple one or more other devices (not shown) or communication equipment to the electronic device 900. Furthermore, additional or fewer interfaces may be utilized. For example, one or more serial interfaces such as Universal Serial Bus (USB) (not shown) may be provided.

A communications subsystem 912 may be provided for one or both of transmitting and receiving signals. Communications subsystems may include any component or collection of components for enabling communications over one or more wired and wireless interfaces. These interfaces may include but are not limited to USB, Ethernet, high-definition multimedia interface (HDMI), Firewire (e.g. IEEE 1394), Thunderbolt™, WiFi™ (e.g. IEEE 802.11), WiMAX (e.g. IEEE 802.16), Bluetooth™, or Near-field communications (NFC), as well as GPRS, UMTS, LTE, LTE-A, dedicated short range communication (DSRC), and IEEE 802.11. Communication subsystem 912 may include one or more ports or other components 920 for one or more wired connections. Additionally or alternatively, communication subsystem 912 may include one or more transmitters (not shown), receivers (not shown), and/or antenna elements 922.

The electronic device 900 of FIG. 9 is merely an example and is not meant to be limiting. Various embodiments may utilize some or all of the components shown or described. Some embodiments may use other components not shown or described but known to persons skilled in the art.

Aspects of the present disclosure may be implemented on any suitable apparatus or apparatuses, which may include one or more computers and/or computer related components.

The teachings of the present disclosure may be implemented at or performed by any network element or combination of network elements. A network element may be a network side electronic device, such as a server, or a user side electronic device, such as a personal computer, a vendor terminal, a mobile device, or any other suitable user side electronic device. These network side and user side devices are only examples and are not intended to be limiting.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A physical vendor crediting system comprising:
a physical vendor material comprising a unique code, each code being associated with a physical vendor identification;
an internet-connected user device configured to receive the unique code from an input and transmit, via an online user activity, the unique code with a user account identification to an online merchant platform; and
a server connected to the online merchant platform for storing a plurality of unique codes, user account identifications, and physical vendor identifications, the server configured to:
create at least one record associating the user account identification transmitted with the unique code to the physical vendor identification previously associated with the unique code, and
generate a transaction to credit the physical vendor based on the online user activity.

2. The system of claim 1, further comprising a relational database for storing the at least one record associating the user account identification to the physical vendor identification.

3. The system of claim 1, wherein the unique code is a serial number, a barcode, or a two-dimensional barcode printed on the physical vendor material.

4. The system of claim 1, wherein the unique code is encoded in a radio-frequency identification (RFID) tag stored on the physical vendor material.

5. The system of claim 1, wherein the physical vendor material is a pre-paid lottery card, a lottery ticket receipt, a flyer, a coupon, or a scratch ticket.

6. The system of claim 1, wherein the server is configured to calculate an amount of the credit based on a number of records associating the same physical vendor identification and user account identification.

7. The system of claim 1, wherein the server is configured to calculate an amount of the credit based on a volume of the online user activity.

8. The system of claim 1, wherein the server is configured to calculate an amount of the credit based on a type of the online user activity.

9. The system of claim 1, wherein the server is configured to calculate an amount of the credit based on a date of the online user activity.

10. A method for crediting a physical vendor based on an online user activity, comprising:
associating, at a server, a unique code of a physical vendor material with a physical vendor identification;
inputting the unique code at an internet-connected user device;
transmitting, via the online user activity, the unique code with a user account identification to an online merchant platform, the online merchant platform being connected to the server;
creating, at the server, at least one record associating the user account identification transmitted with the unique code to the physical vendor identification previously associated with the unique code; and
generating a transaction to credit the physical vendor based on the online user activity.

11. The method of claim 10, further comprising storing the at least one record associating the user account identification to the physical vendor identification in a relational database.

12. The method of claim 10, wherein the unique code is a serial number, a barcode, or a two-dimensional barcode printed on the physical vendor material.

13. The method of claim 10, wherein the unique code is encoded in a radio-frequency identification (RFID) tag stored on the physical vendor material.

14. The method of claim 10, wherein the physical vendor material is a pre-paid lottery card, a lottery ticket receipt, a flyer, a coupon, or a scratch ticket.

15. The method of claim 10, further comprising calculating an amount of the credit based on a number of records associating the same physical vendor identification and user account identification.

16. The method of claim 10, further comprising calculating an amount of the credit based on a volume of the online user activity.

17. The method of claim 10, further comprising calculating an amount of the credit based on a type of the online user activity.

18. The method of claim 10, further comprising calculating an amount of the credit based on a date of the online user activity.
